(19) United States
(12) Patent Application Publication
(10) Pub. No.: US 2017/0140669 A1
(43) Pub. Date: May 18, 2017

(54) VIRTUAL LAB FOR HANDS-ON LEARNING USING TANGIBLE USER INTERACTIONS

(71) Applicant: International Business Machines Corporation, Armonk, NY (US)

(72) Inventors: Prasenjit Dey, BANGALORE (IN); Mukesh K. Mohania, NEW DELHI (IN); Satya V. Nitta, CROSS RIVER, NY (US); Nitendra Rajput, HARYANA (IN)

(21) Appl. No.: 14/941,043

(22) Filed: Nov. 13, 2015

(51) Int. Cl. G09B 23/00; G06F 3/0484; G06F 3/01; G09B 5/02; G09B 9/00

(52) U.S. Cl. CPC G09B 23/00; G09B 5/02; G09B 9/00; G06F 3/017; G06F 3/0484

(57) ABSTRACT

A method, system and computer program product are disclosed for performing a virtual experiment using one or more mobile communications devices. In the virtual experiment, one or more users tangibly manipulate one or more mobile devices to simulate an experiment. Each of the mobile devices includes sensors, and these sensors sense a set of parameters of the mobile devices and generate parameter signals. In an embodiment, the method includes processing the parameter signals according to a set of rules to generate processed signals; and using the processed signals to generate a display on one or more of the mobile devices to show features of the simulated experiment. In embodiments of the invention, the method further comprises authoring content for the experiment including declaratively creating the content for the experiment and an associated effect of the content on the experiment to create an experiment manifest.

### BACKGROUND

This invention generally relates to virtual laboratories, and more specifically, to virtual laboratories in which users tangibly interact with mobile devices or computer devices in virtual experiments.

Modern technology such as new telecommunication devices, new computer technologies, and the Internet are having an important impact on traditional education such as classroom and laboratory teaching. Mobile communication devices are becoming de-facto platforms for education delivery and content consumption. Online learning is being driven both from the massively open online course (MOOC) community, as well as the traditional education system in the form of blended learning.

Aspects of experimental learning that were in the form of science laboratory have not yet found a solution in this new form of education delivery.

Traditional laboratory education has a number of limitations. For instance, traditional laboratory systems have the challenge of cost and space, especially in growth market economies. Also, some experiments in the actual laboratory have the element of risk of accidents when handling explosive or corrosive chemicals, electricity, specimen animals, etc. In addition, laboratories can be used only at specific hours, which can limit a student's desire to learn and experiment.

### SUMMARY

Embodiments of the invention provide a method, system and computer program product for performing a virtual experiment using one or more mobile communications devices. In the virtual experiment, one or more users tangibly manipulate one or more of the mobile communications devices to simulate a pre-specified experiment. Each of the mobile communications devices includes a plurality of sensors, and these sensors sense a set of pre-defined parameters of the one or more of the mobile communications devices and generate parameter signals. In an embodiment, the method includes processing the parameter signals according to a set of pre-defined rules for the simulated experiment to generate processed signals, and using the processed signals to generate a display on one or more of the mobile communications devices to show pre-specified features of the simulated experiment.

In an embodiment, the tangibly manipulating one or more of the mobile communications devices includes moving, and showing a specified display on, a first of the mobile communications devices, and the using the processed signals includes using the processed signals to identify to a second of the mobile communications devices the moving of and the specified display shown on the first of the mobile communications devices.

In embodiments of the invention, the method further comprises authoring content for the experiment including declaratively creating the content for the specified experiment and an associated effect of the content on the specified experiment to create an experiment manifest.

In embodiments, the tangibly manipulating one or more of the mobile communications devices includes one or more of tilting, shaking, touching, rotating, proximity of the devices, or moving the one or more of the mobile communications devices, or exposing the one or more of the mobile communications devices to light or other sensory input.

Embodiments of the invention further comprise authoring content for the experiment by performing cognitive content search and parsing the content in one or more documents automatically to generate an experiment manifest.

Embodiments of the invention further comprise creating modules/representations, said modules/representations being a combination of sensor inputs specified in a rules engine to lead to movements and effects for different experiments.

Embodiments of the invention further comprise pre-configuring the one or more mobile communications devices with specified data and instructions for the simulated pre-specified experiment according to the experiment manifest. This pre-configured data identifies the set of parameters, and the pre-configured instructions include the set of rules.

In embodiments of the invention, the sensing a set of pre-determined parameters includes using the sensors of the one or more of the mobile communication devices to measure the tangibly manipulating of the one or more of the mobile communications devices.

In embodiments of the invention, the processing the parameter signals includes using the one or more of the mobile communications devices to process the parameter signals.

In embodiments, the processing the parameter signals includes filtering the parameter signals to obtain filtered signals, and combining the filtered signals according to the set of rules.

In embodiments, the manipulating one or more of the mobile communications devices includes moving a first of the mobile communications devices in a defined manner, and the sensing a set of parameters includes using one of the sensors of the first mobile communications device to sense said moving of the first mobile communications device and to generate a signal representing said moving.

In embodiments of the invention, the using the set of second signals to generate a display includes transmitting the second set of signal to a rendering module on a first of the mobile communications devices, and the second set of signals causing the rendering module to generate a visualization on a display area of the first mobile communications device showing a specified result of the simulated experiment.

In embodiments of the invention, devices which have a wide variety of sensors (camera, microphone, gyroscope, accelerometer, GPS), and a wide variety of interactions, when driven with cognitive content, can be packaged for building a compelling virtual but hands-on laboratory experience.

Embodiments of the invention create a virtual experiment/lab using one or more communication devices, and allowing users using the communication devices to author/create content to be used in an experiment or use the content that is provided by the system itself. Embodiments of the invention identify learning constructs that are required for the experiment and build representations that combine multiple sensor input from the communication devices to define an interaction in the experiment. Embodiments of the invention allow a user to create content for a virtual lab to develop tangible experiments on one or more communication devices by using virtual laboratory elements such as lens, rays, acids, bases, salts, plants, etc., but not limited to these only.

Embodiments of the invention employ tangible interactions to produce a more realistic feel to the virtual experiments and to enhance the user experience with virtual experiments. A tangible user interface (TUI) is one in which the user interacts with a digital system through the manipulation of physical objects linked to and directly representing a quality of the system. The TUIs give a direct link between the system and the way a person controls the system through physical manipulations by having an underlying meaning or direct relationship which connects the physical manipulations to the behaviors which they trigger on the system.

In embodiments of the invention, the tilting of a phone, for example, to simulate pouring a chemical has a direct link to the physical world (this is how pouring is done in the physical world), but there is a consequence of the pouring in the digital world (mixing of chemicals and the occurrence of reactions and color/property change). In a biology example, when light is shined on a simulated plant, the plant is shown to grow in the digital interface. This has a direct relation in the physical world, where sunlight results in photosynthesis which makes a plant grow.

### BRIEF DESCRIPTION OF THE DRAWINGS

FIG. 1 shows a solution architecture for experiment creation.

FIG. 2 illustrates a solution architecture for runtime experiment execution.

FIG. 3 shows a metadata model for the content of virtual experiments in an embodiment of the invention.

FIG. 4 shows a metadata model for the interactions of virtual experiments using an embodiment of the invention.

FIG. 5 depicts a virtual chemistry lab experiment using an embodiment of the invention.

FIG. 6 illustrates a further chemistry lab experiment using an embodiment of the invention.

FIG. 7 shows another virtual chemistry lab experiment using an embodiment of the invention.

FIG. 8 shows a virtual chemistry lab experiment, using an embodiment of the invention, in which two chemicals are reacted.

FIG. 9 illustrates a virtual experiment including cognitive content and using an embodiment of the invention.

FIG. 10 displays an example of a virtual lab manifest in an embodiment of the invention.

FIG. 11 shows several examples of virtual physical lab experiments using embodiments of the invention.

FIG. 12 depicts two virtual biology lab experiments using embodiments of the invention.

FIG. 13 is a block diagram illustrating a mobile communications device that may be used in embodiments of the invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including

instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention are used for performing virtual laboratory experiments using commodity sensor hardware such as mobile devices using tangible interactions. Each device becomes a tangible object metaphor (test tubes, beakers, lens, planet, etc.) of the laboratory and their physical interactions (pouring liquid from one device to the other by tilting, shaking, catalysis, proximity of one to the other, rotation, etc.) creates the feel of a real experiment being performed, except that objects are physical tangible metaphors such as mobile devices.

Embodiments of the invention provide a powerful authoring and meta-data framework which allows the parties in the ecosystem to declaratively create more and more new reactions without requiring any change in the application code. The meta-data model creates a rich experiment manifest which results in automatic initialization of an experiment in the application. This is very powerful since it enables the ecosystem which can lead to the creation of a huge repository of experiments.

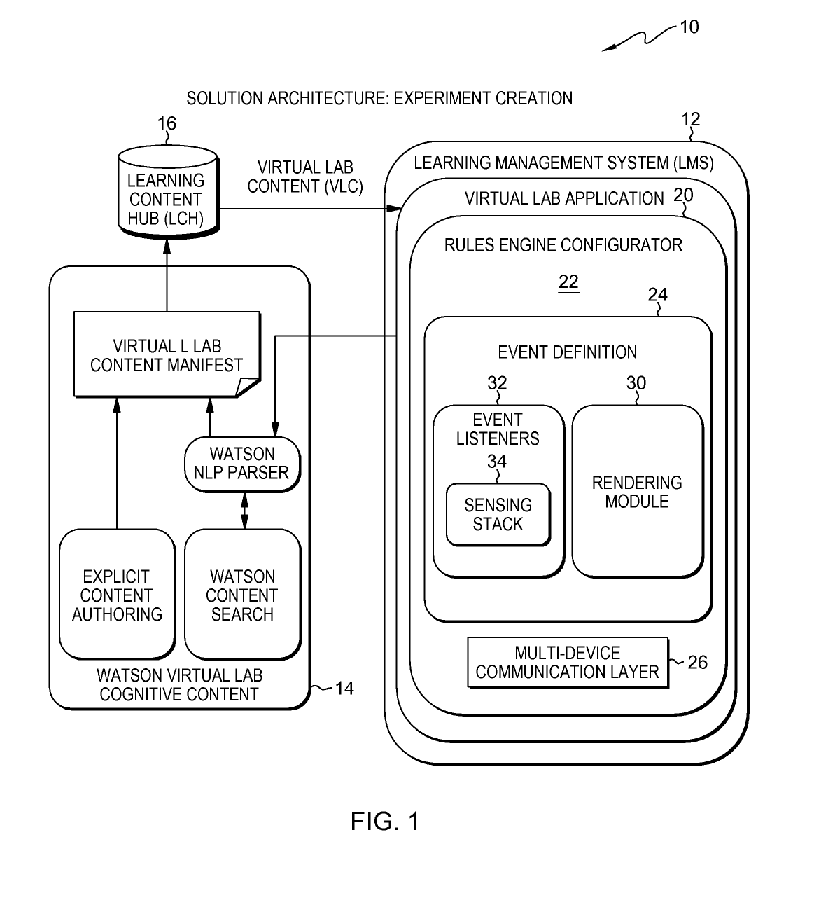

FIG. 1 illustrates a solution architecture 10 for experiment creation. The architecture comprises a learning management system (LMS) 12, a virtual lab cognitive content 14, and a learning content hub 16. The learning management system 12 includes virtual lab application 20, and rules engine configurator 22, and the rules engine configurator includes event definition 24 and multi-device communication layer 26. Event definition 24 includes rendering module 30 and event listeners 32, which in turn includes sensing stack 34. The virtual Lab Cognitive Content 14 includes virtual lab content manifest 36, NLP parser 40, an explicit content authoring module 42, and a content search module 44

The virtual Lab Application 20 sits inside an LMS or could be an independent application. The Rule Engine Configurator 22 takes input from the VLC 16 content and configures specific rules required for an experiment. As examples, these rules could be: a color of an item should change by X % on shaking Y units, or a volume should increase by a units on pouring b units, or a single of multi-device interaction experiment.

The Event Definition system 24 defines the different events that are required for an experiment. These events could be, for example, shake, tilt, etc. The Event Listeners 32 identify the combination of sensors that will be required to compute an event. For instance, input from gyroscopic and accelerometer sensors may be combined in a manner that will give a tilt. The sensing stack 34 is the list of sensors required for an experiment. The rendering module 30 has all the visualization components required for an experiment on single or multi-device interaction.

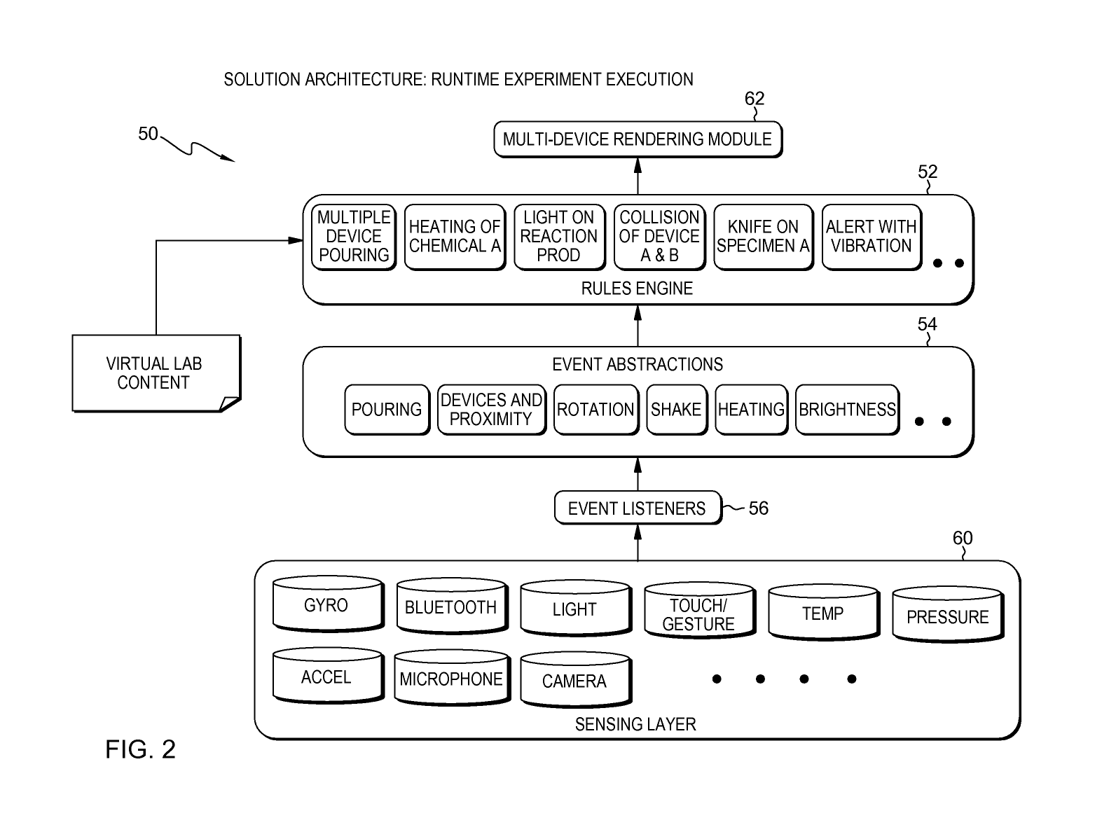

With reference to FIG. 2, the solution architecture 50 for runtime experiment execution comprises a rules engine 52, event abstraction 54, event listeners 56, sensing layer 60, and a rendering module 62.

The Rules Engine 52 includes a series of rules for processing various events. These events may include, for example, multiple device pouring, heating of a chemical, light or reaction products, collision of particles, knife on a specimen, alert with vibration. Event abstractions 54 include, for example, pouring, devices and proximity, rotation, shake, heating and brightness.

The sensing layer 60 includes a multitude of sensors. These include, for example, gyroscope, Bluetooth, light, touch/gesture, temperature, pressure acceleration, microphone and camera.

In an embodiment of the invention, the sensing layer 60 manages the sensors of the mobile devices. When a device is tilted, rotated or moved, this is sensed by the sensor on the device and passed on to the sensing layer 60. The sensing layer events are passed on to specific event listeners 56 which listen for particular events and take actions. Since the data from event listeners may be just individual events from the sensors which also may have noise, these data are filtered and refined to get actual atomic event abstractions 54 such as pouring, proximity of devices, heating etc.

These higher level abstraction events are then sent to the rules Engine 52 which combines these events according to given rules. These rules are defined in the Virtual Lab Manifest (defined by the user) which feeds the rules engine. For example when a device liquid is poured into another device, the rules engine recognizes that this type of mixing should result in change of color of the liquids after mixing. Similarly if a phone is rotated, the ball should move towards the periphery etc. Some reactions may have a rule where mixing of the chemicals should not result in color change but only when the device is shaken etc. Once these rules are parsed, appropriate visualization is effected on the display of the device by the Multi-Device Rendering module 62.

The rules engine 62 has well defined rules defined by the user in the Editor. For example if Chemical A and Chemical B are MIXED and then HEATED, they result in Product C and Product D. The user also defines the physical properties of the products, such as Product C has higher DENSITY than Product D. The COLOR of CHEMICALS may also be given by these rules. The Rules engine defines the chemical/entity properties and what should happen under what conditions. This is then parsed in the rules engine which then makes the system operate in the desired manner when different experiments are happening.

In embodiments of the invention, an experiment manifest is created for each experiment, and this experiment manifest is the final specification of the experiment. The experiment manifest may be created by declaratively creating the content for a specified experiment and an associated effect of the content on the specified experiment. In embodiments of the invention, the experiment manifest may be created, as discussed in more detail below, by using a cognitive system and parsing the content of one or more documents.\

Below is an example of an experiment manifest which shows how the user defined rules in an editor look like which is parsed in the rules engine.

<?xml version=“1.0” encoding=“UTF-8”?> [symbol]
<interaction>

<mixing>drops, pour</mixing> [symbol]
<catalysis>

<light>yes/no</light>
<shake>yes/no</shake>
<heat>yes/no</heat>

</catalysis>
<color>red, green, blue...</color>
<bubble>yes/no</bubble>
<smoke>yes/no</smoke>
<explosion>yes/no</explosion>
<delay>milliseconds</delay> [symbol]
<sedimentation>

<result>yes/no</result>
<color> ......</color>
<form> powder, lumpy ...</form>

</sedimentation> [symbol]
<chemical>

<name>......</name>
<formula>......</formula>
<color>red, green, blue...</color>
<density>high, medium, low</density>
<smell>....</smell>
<image>....</image>
<info>......</info>

</chemical>

</interaction>

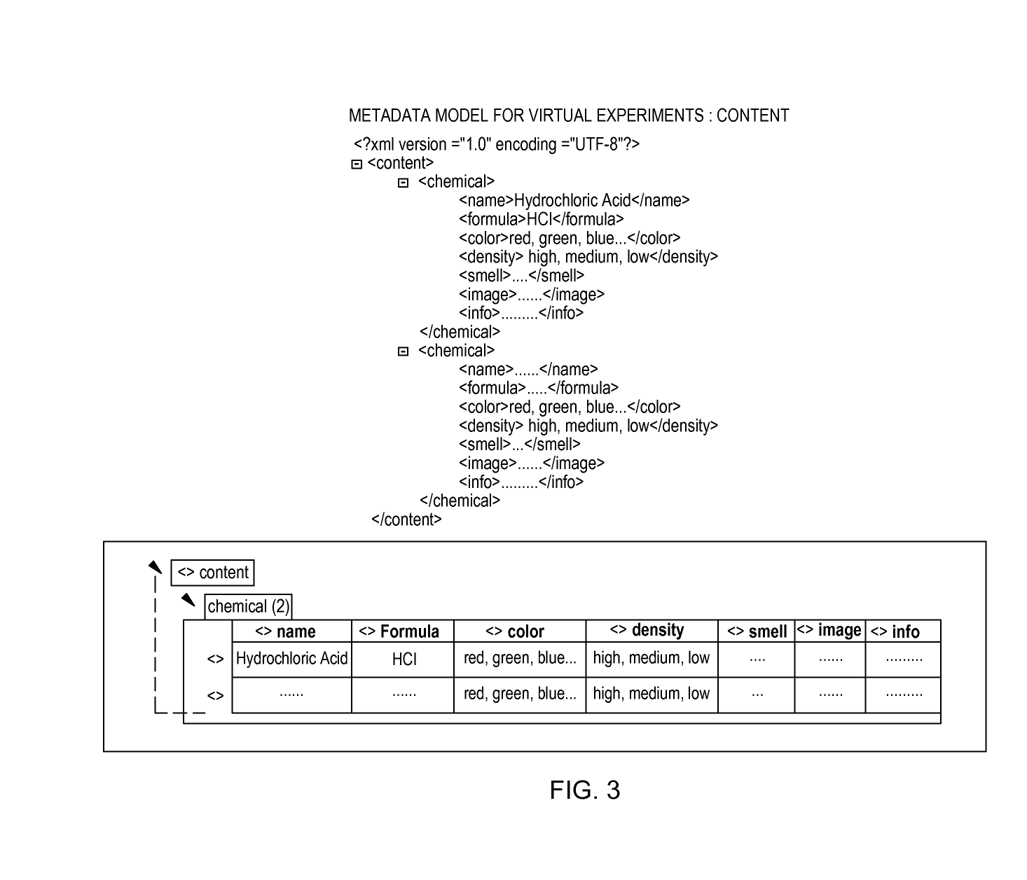

FIG. 3 shows a metadata model for virtual experiments. The model identifies the contents for an experiment and metadata about those contents. In the example of FIG. 3, the contents are chemicals, and the metadata describes features or properties of those chemicals such as their names, formula, color and density.

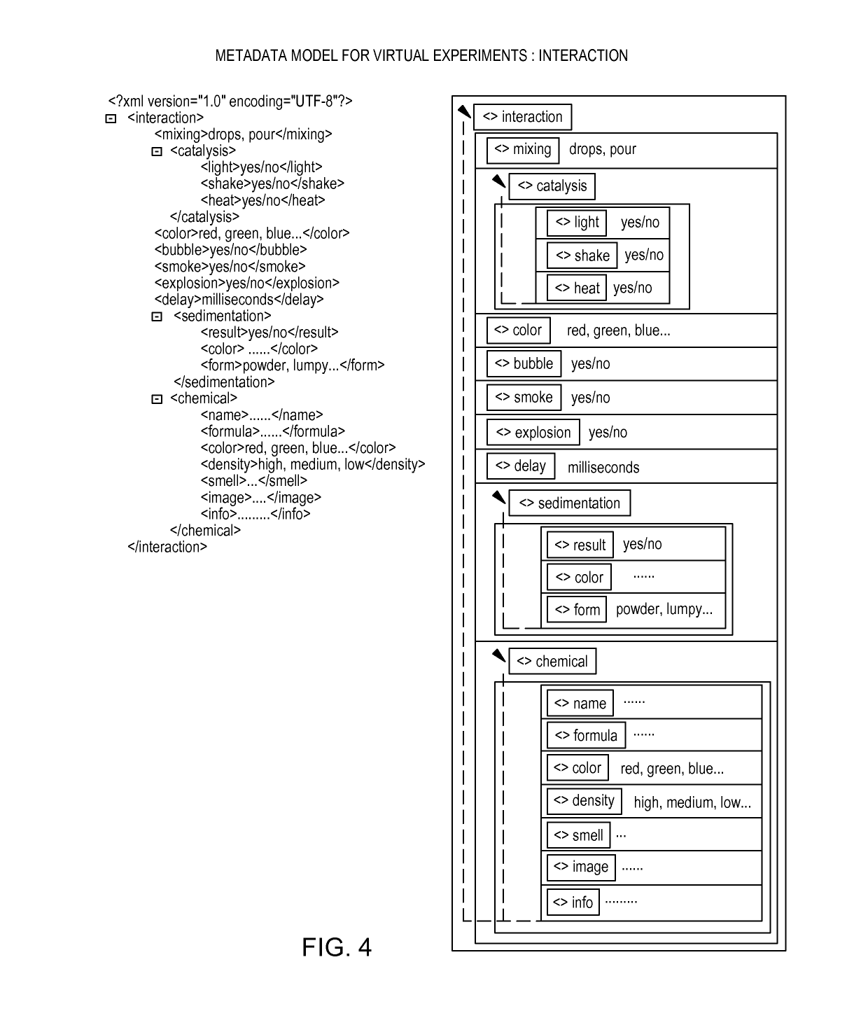

FIG. 4 shows a metadata model for interactions in virtual experiments. In this example, the metadata includes data related to mixing chemicals. The metadata identifies a chemical and lists properties or qualities of the chemical, and identifies other features or properties relating to mixing the chemical. These other features include catalysts that might be used with the chemical and data about sedimentation.

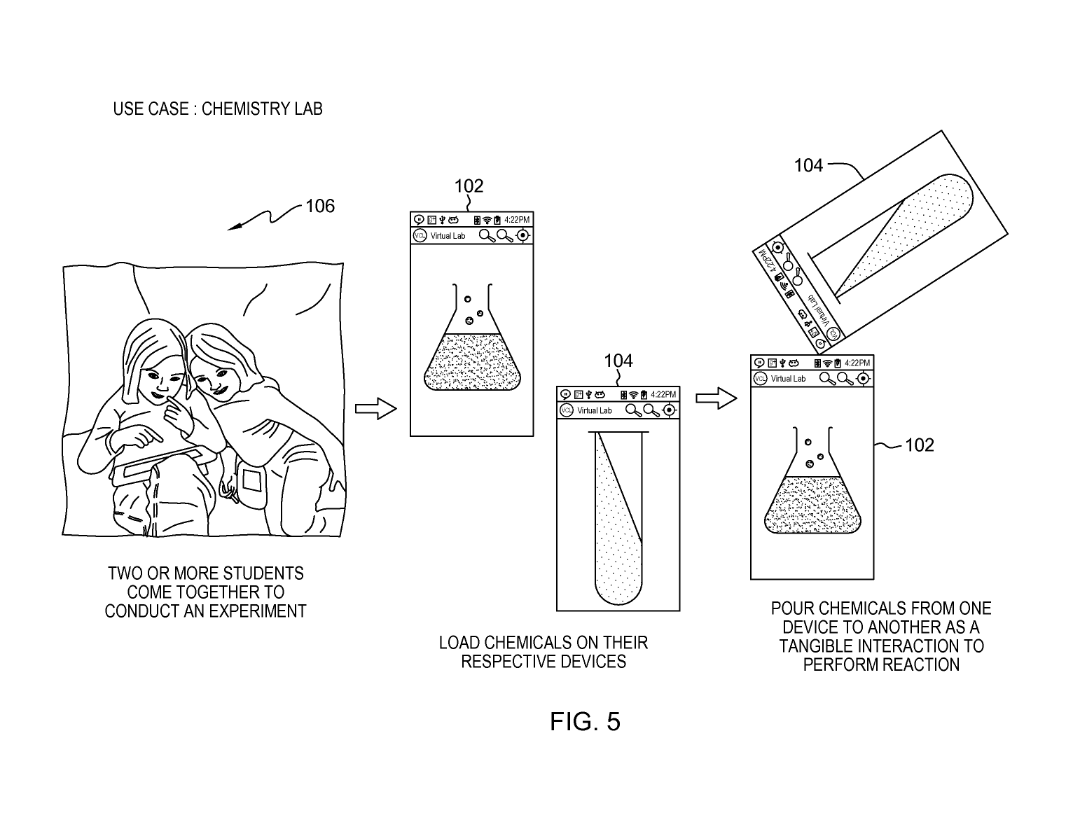

FIGS. 5-12 illustrate a number of virtual experiments that may be conducted in embodiments of the invention.

FIG. 5 illustrates a virtual chemistry lab experiment. In this virtual experiment, each of two mobile devices 102, 104 shows a container with a chemical in the container. The two devices are manipulated as if the displayed containers and chemicals were real, and the chemical from one of the containers is poured into the other container.

In this virtual experiment, and as depicted in FIG. 5, two or more students 106 come together to conduct an experiment, the students load chemicals on their respective mobile devices, and pour chemicals from one device to another as a tangible interaction to perform a reaction.

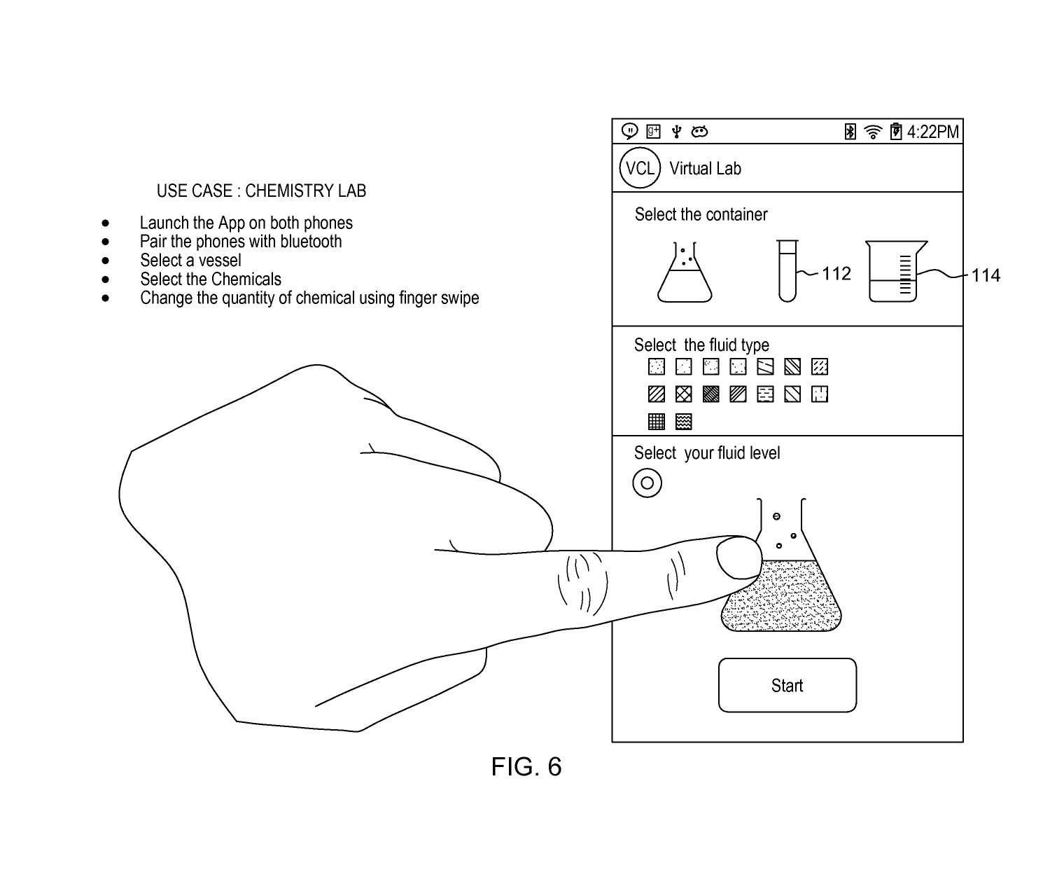

FIG. 6 illustrates a virtual procedure for filing a vessel in a virtual chemistry lab. In this procedure, the application is launched on two phones, represented at 112, 114, and the phones are paired with a wireless connection. A user selects a vessel, and selects the chemicals. The user may change the quantity of chemical using a finger swipe.

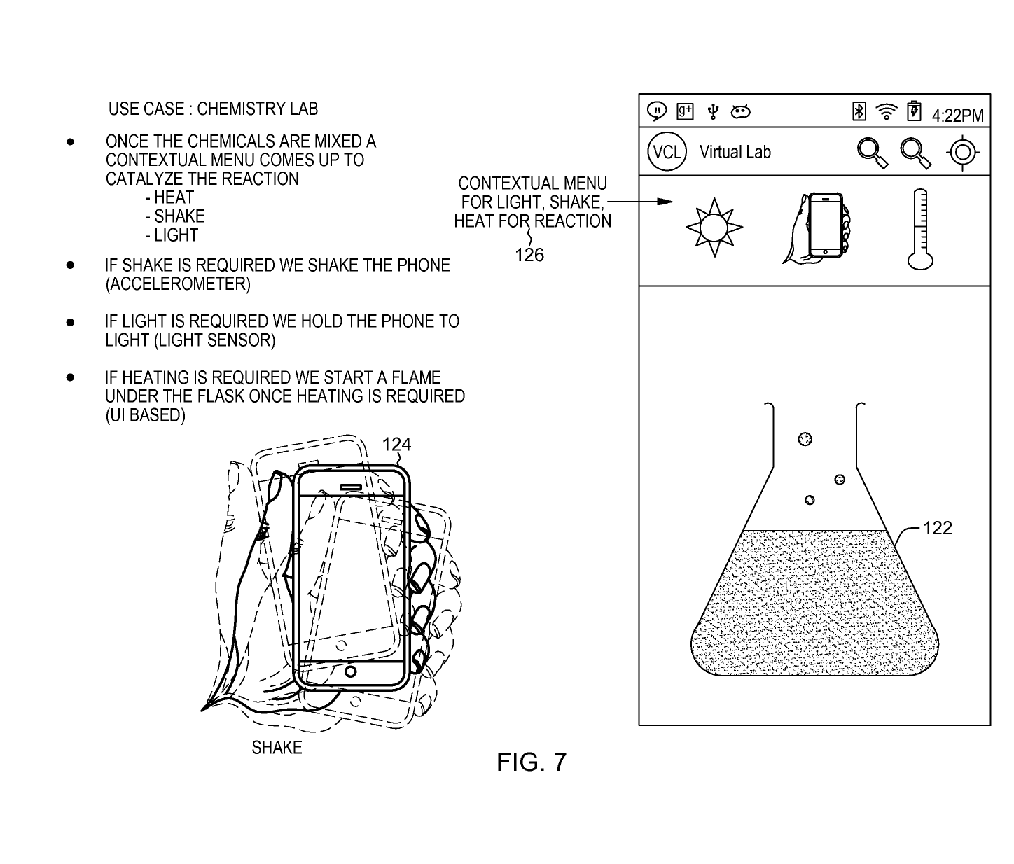

FIG. 7 shows another virtual chemistry experiment. In this virtual experiment, chemicals are mixed in a flask 122 shown on a mobile phone 124. Once the chemicals are mixed, a contextual menu is displayed to catalyze the reaction between the chemicals. This contextual menu may indicate, for example, that heat, shaking, or light is used to catalyze the reaction.

If shaking is required, the user shakes the phone, and this is sensed by an accelerometer on the phone. If light is required, the user holds the phone to light, which is sensed by a light sensor. If heating is required, a virtual flame is started under the flask.

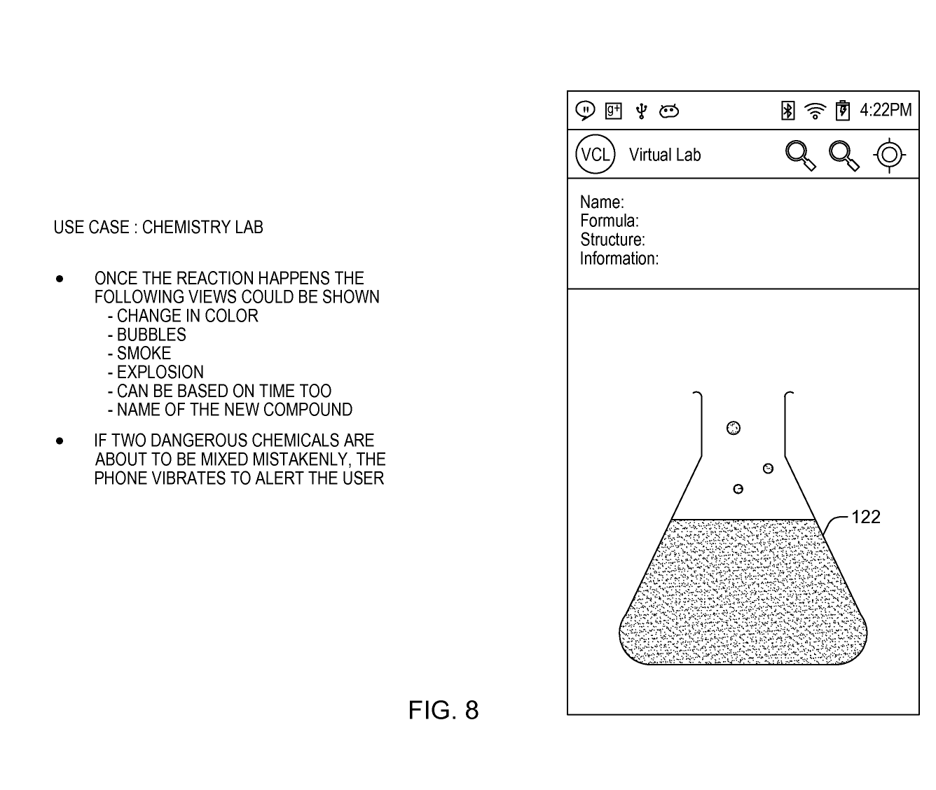

With reference to FIG. 8, once the reaction occurs, the following can be shown on the phone display: a change in color of the fluid in the flask, bubbles, smoke, or an explosion. The chemical reaction can also be based on time. If the reaction results in a new compound, the name of the new compound can be displayed on the phone.

The phone may be provided with other features relating to the virtual chemical reaction. For instance, in embodiments of the invention, if two dangerous chemicals are about to be mixed mistakenly, the phone vibrates to alert the user.

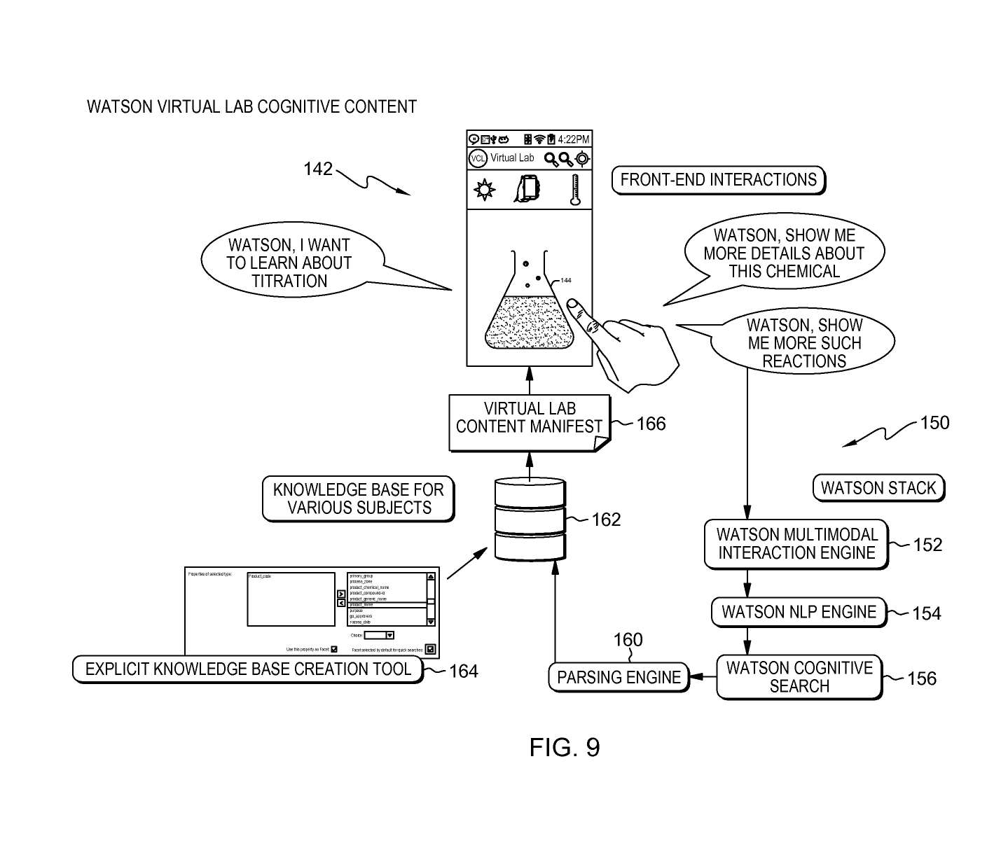

FIG. 9 shows a virtual chemistry experiment involving cognitive content. In this virtual experiment, a display 142 is shown of a chemical in a flask 144. The student asks a cognitive system 150 for related information. For instance, the student may ask to learn about titration, for more details about the chemicals, or to be shown similar reactions.

To answer these questions, the cognitive system 150 uses a Multimodal Interaction Engine 152, an NLP engine 154, a Cognitive Search Engine 156, and a Parsing Engine 160. The cognitive system may search through a Knowledge base 162 and may also use an Explicit Knowledge Base Creation Tool 164. Answers to the questions asked by the student are provided by a Virtual Lab Content Manifest 166. Any suitable cognitive system may be used in embodiments of the invention. For example, the Watson Cognitive Computing system provided by the International Business Machines Corporation may be used.

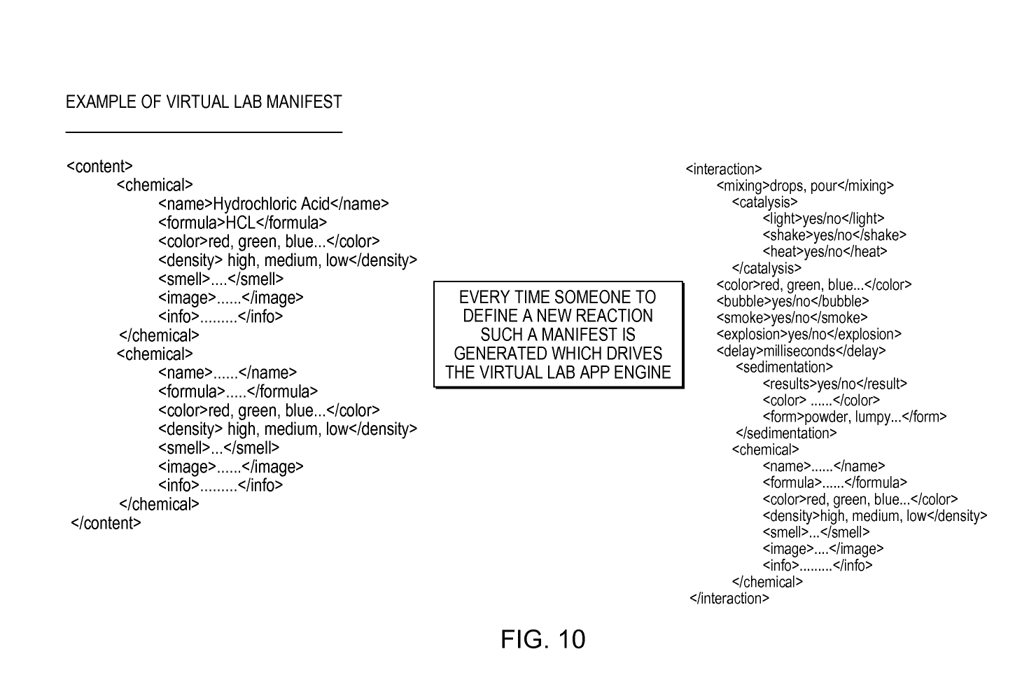

FIG. 10 shows an example of a Virtual Lab Manifest. Such a manifest is generated every time someone wants to define a new reaction, and the manifest drive the Virtual Lab Application engine. The manifest lists the chemical or chemicals used in the experiment of FIG. 9 and lists properties and characteristics of these chemicals.

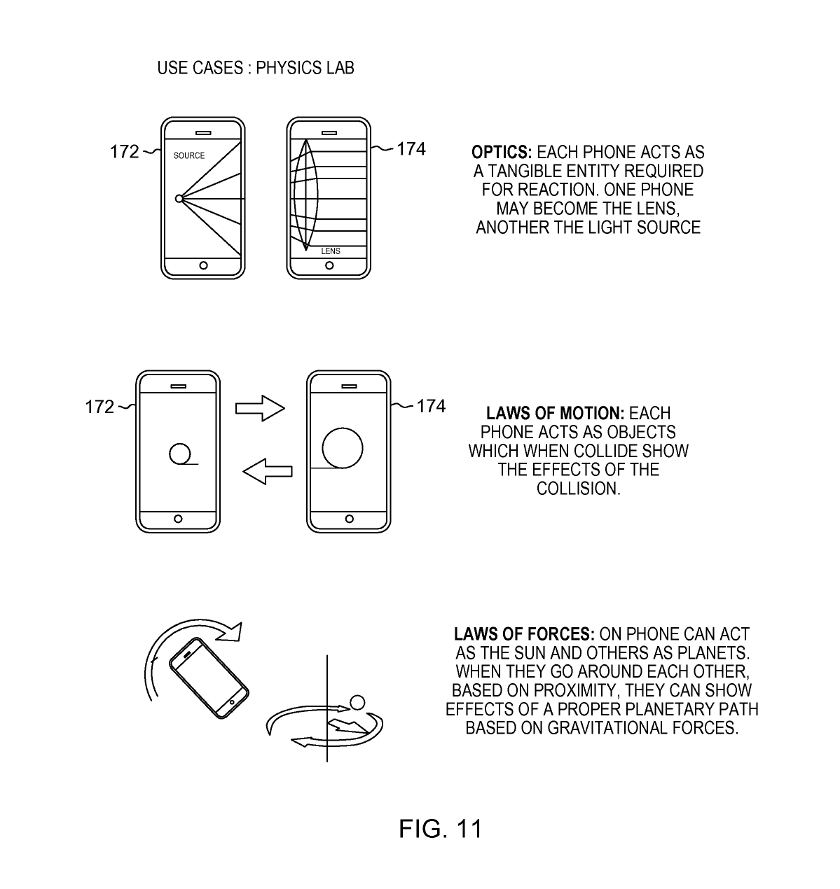

FIG. 11 illustrates virtual physics lab experiments. In these experiments, each phone 172, 174 acts as a tangible entity required for a reaction. To demonstrate optics, for example, one phone may become a virtual lens, another a virtual light source. To demonstrate laws of motion, each phone acts as an object which, when the phones collide, shows the effects of the collision. In another experiment, to demonstrate laws of forces, one phone can act as the sun and other phones act as planets. When the phones go around each other, based on proximity, the phones can show the effects of a proper planetary path based on gravitational forces.

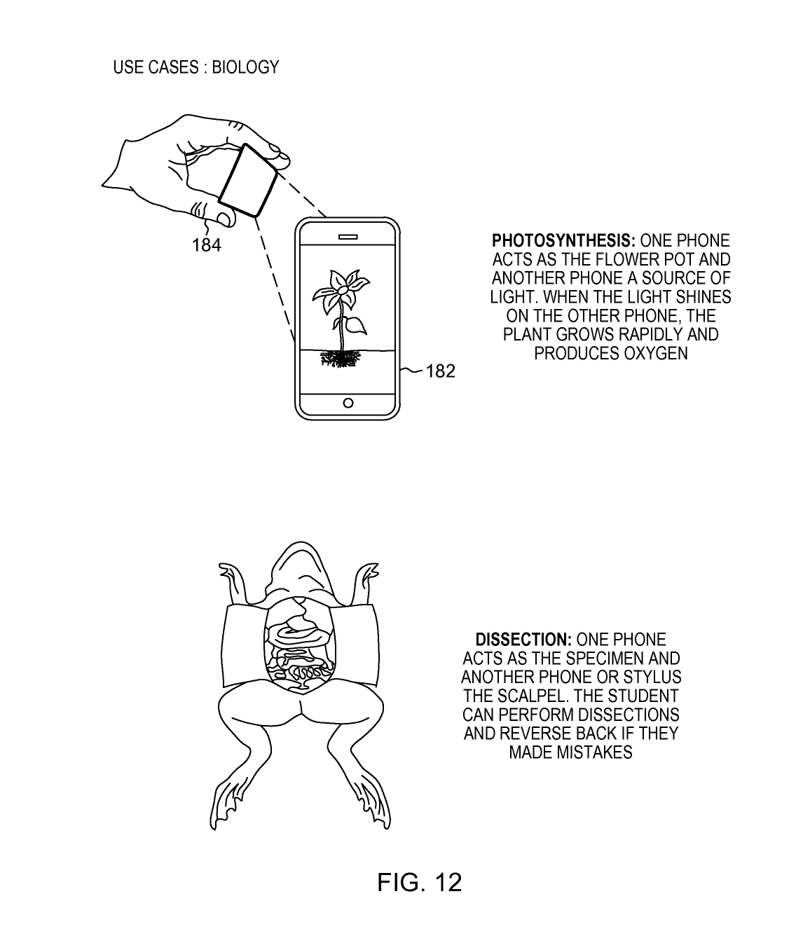

FIG. 12 shows virtual biology experiments that may be conducted using embodiments of the invention. One experiment demonstrates photosynthesis. In this experiment, one phone 182 acts as a flower pot and another phone 184 acts as a source of light. When the light shines on the other phone, the plant grows rapidly and produces oxygen.

A second biology experiment demonstrates dissection. One phone acts as the specimen and another phone or stylus acts as the scalpel. The student can use the latter phone to dissect virtually the specimen. Also, in embodiments of the invention, the dissection can be reversed if the student makes a mistake.

Any suitable mobile devices may be used in embodiments of the invention. The mobile devices are representative of any appropriate type of device that include a smart phone, a cell phone, a portable phone, a Session Initiation Protocol (SIP) phone, a video phone, or single-purpose mobile devices such as eBooks. The mobile device may also be a portable computing device, such as a tablet computer, laptop, a personal digital assistant (“PDA”), a portable email device, a thin client, a portable gaming device, etc.

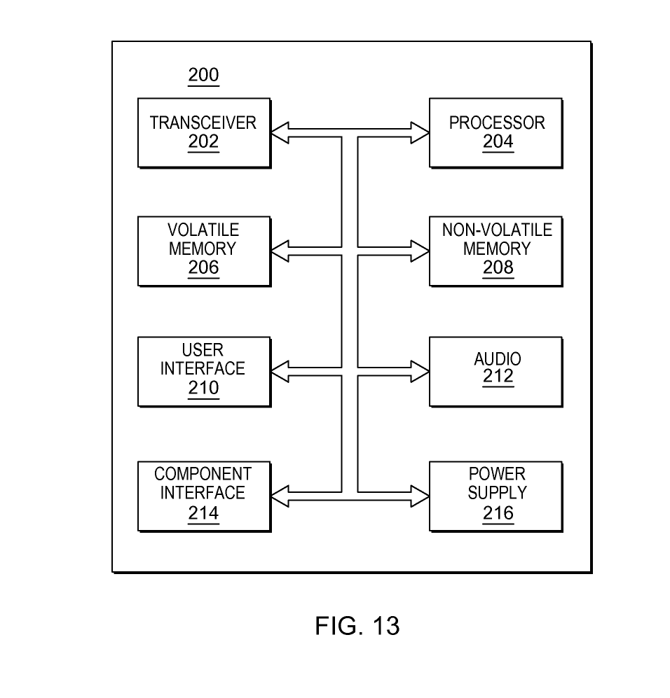

FIG. 13 illustrates in a block diagram one embodiment, as an example, of a mobile communications device 200 that may be used in embodiments of the invention. Generally, device 200 includes transceiver 202, processor 204, volatile memory 206, a non-volatile memory 208, user input interface 210, a user output device 212, component interface 214, and power supply 216.

In embodiments of the invention, mobile device 200 is capable of accessing one or more networks, which may be a cellular phone network or a computer network, and the mobile device may also support one or more applications for performing various communications with a cellular or computer network. The mobile device 200 may be a wireless device and may receive or transmit data and signals wirelessly.

Transceiver 202 is capable of sending data to and receiving data from a network to which the mobile device is connected. Processor 204 executes stored programs, and volatile memory 206 and non-volatile memory 208 are available to and used by the processor 204. User input interface 210 may comprise elements such as a keypad, display, touch screen, and the like. User output device may comprise a display screen and an audio interface 212 that may include elements such as a microphone, earphone, and speaker. Component interface 214 is provided to attach additional elements to the mobile device such as a universal serial bus (USB) interface.

Embodiments of the invention provide a number of important inventions. A virtual lab provides experiential learning without the cost, risks, and infeasiblity of an actual lab. Embodiments of the invention encourage group interactions and learning as each device can play a role in the experiment, and learning can happen anywhere without the requirement of lab hours. In addition, students are encouraged to try virtual experiments without fear and then go on to do actual experiments. Also, the use of cognitive content in embodiments of the invention can make the learning limitless.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

What is claimed is:

1. A method of performing a virtual experiment using a plurality of mobile communications devices, each of the mobile communications devices including a display screen and a plurality of sensors, the method comprising:
showing on the display screen of each of the mobile communications devices a view of one part of a specified experiment, wherein in said pre-specified experiment, said parts are moved relative to each other in a defined way;
one or more users tangibly manipulating the plurality of the mobile communications devices relative to each other to manipulate said views of the parts of the pre-specified experiment relative to each other in said defined way to simulate movement of said parts in the specified experiment;
defining events required for the virtual experiment;
identifying a list of the sensors needed to sense the defined events required for the virtual experiment;
the listed sensors of the one or more of the mobile communications devices sensing a set of pre-defined parameters of the one or more of the mobile communications devices and generating sensor output signals;
a plurality of event listeners receiving the sensor output signals from the listed sensors;
the event listeners processing the sensor output signals, and sending processed output to a rules engine;
the rules engine combining said processed output according to a set of pre-defined rules for the virtual experiment to recognize results of the tangibly manipulating the plurality of the mobile communications devices and to generate rules engine output signals; and
using the rules engine output signals to generate displays on the display screens of the mobile communications devices to show specified features of the virtual experiment to simulate the specified experiment.

2. The method according to claim 1, wherein:
the tangibly manipulating one or more of the mobile communications devices includes moving and showing a specified display on a first of the mobile communications devices; and
the using the rules engine output signals includes using the rules engine output signals to identify to a second of the mobile communications devices the moving of the specified display shown on the first of the mobile communications devices.

3. The method according to claim 1, further comprising authoring content for the experiment including declaratively creating the content for the specified experiment and an associated effect of the content on the specified experiment to create an experiment manifest.

4. The method according to claim 1, wherein the tangibly manipulating one or more of the mobile communications devices includes one or more of tilting, shaking, touching, rotating, or moving the one or more of the mobile communications devices, or exposing the one or more of the mobile communications devices to light or other sensory input.

5. The method according to claim 1, further comprising authoring content for the experiment by performing cognitive content search and parsing content of one or more documents automatically to create an experiment manifest of the specified experiment.

6. The method according to claim 1, further comprising:
creating modules/representations, said modules/representations being a combination of sensor inputs specified in the rules engine to lead to movements and effects for different experiments; and
pre-configuring the one or more mobile communications devices with specified data and instructions for the simulated pre-specified experiment; and wherein:
the pre-configured data identifies said set of parameters, and said pre-configured instructions includes said set of rules.

7. The method according to claim 1, wherein the sensing a set of pre-determined parameters includes using the sensors of the one or more of the mobile communication devices to measure the tangibly manipulating of the one or more of the mobile communications devices.

8. The method according to claim 1, wherein the processing said parameter signals includes:
using the one or more of the mobile communications devices to process the parameter signals;
filtering the parameter signals to obtain filtered signals; and
combining the filtered signals according to the set of rules.

9. The method according to claim 1, wherein:
the manipulating one or more of the mobile communications devices includes moving a first of the mobile communications devices in a defined manner; and
the sensing a set of parameters includes using one of the sensors of the first mobile communications device to sense said moving of the first mobile communications device and to generate a signal representing said moving.

10. The method according to claim 1, wherein the using the rules engine output signals to generate a display includes:
transmitting the rules engine output signal to a rendering module on a first of the mobile communications devices; and
said rules engine output signals causing the rendering module to generate a visualization on a display area of the first mobile communications device showing a specified result of the simulated experiment.

11. A system for performing a virtual experiment, comprising:
a plurality of mobile communications devices, each of the mobile communications devices including a display screen for showing a view of one part of a specified experiment, wherein in said experiment, said parts are moved relative to each other in a defined way;
a plurality of sensors on the mobile communications devices; and
a processing sub-system including an event definition system, a plurality of event listeners and a rules engine; and wherein:
the event definition system defines events for the virtual experiment;
the event listener identifies a list of the sensors needed to sense the defined events for the virtual experiment;
when one or more users tangibly manipulates the plurality of mobile communications devices relative to each other to manipulate said views of the parts of the specified experiment relative to each other in said defined way to simulate movement of said parts in the specified experiment, the listed sensors on the mobile communications devices sense a set of pre-defined parameters of the mobile communications devices during said manipulating and generate sensor output signals, and the plurality of event listeners receiving the sensor output signals from the listed sensor;
the processing sub-system operates the event listeners to process the sensor output signals and send processed output to the rules engine, and operates the rules engine to combine said processed output according to a set of pre-defined rules for the virtual experiment to recognize results of the tangibly manipulating one or more of the mobile communications devices and to generate rules engine output signals; and
at least one of the mobile communications devices use the rules engine output signals to generate a display on said at least one mobile communications device to show specified features of the virtual experiment to simulate the specified experiment.

12. The system according to claim 11, wherein:
the at least one mobile communications device is configured with specified data and instructions for the simulated specified experiment; and
the pre-configured data identifies said set of parameters, and said pre-configured instructions includes said set of rules.

13. The system according to claim 11, wherein the processing sub-system includes a processing unit on at least one of the mobile communications devices.

14. The system according to claim 11, wherein the processing sub-system:
filters the parameter signals to obtain filtered signals; and
combines the filtered signals according to the set of rules.

15. The system according to claim 11, wherein:
the manipulating one or more of the mobile communications devices includes moving a first of the mobile communications devices in a defined manner; and
the sensors on the at least one mobile communications device sense said moving of the first mobile communications device and generating signals representing said moving.

16. A computer program product comprising:
a computer readable hardware storage medium having computer program code tangibly embodied therein for visualizing aspects of a virtual experiment, wherein in said virtual experiment one or more users tangibly manipulate a plurality of mobile communications devices to simulate a specified experiment, each of the mobile communications devices including a display screen for showing a view of one part of the specified experiment, wherein in said experiment, said parts are moved relative to each other in a defined way, and a plurality of sensors, the computer program code, when executed in a computer system, performing the following:
defining events for the virtual experiment;
identifying a list of the sensors needed to sense the defined events for the virtual experiment;
when one or more users manipulates the plurality of mobile communications devices relative to each other to manipulate said views of the parts of the pre-specified experiment relative to each other in said defined way to simulate movement of said parts in the pre-specified experiment, the listed sensors on the mobile communications devices sense a set of pre-defined parameters of the mobile communication devices during said manipulating and generate sensor output signals, and the plurality of event listeners receiving the sensor output signals from the listed sensors;
the event listeners processing the sensor output signals, and sending processed output to a rules engine
the rules engine combining said processed output according to a set of pre-defined rules for the virtual experiment to recognize results of the tangibly manipulating one or more of the mobile communications devices and experiment to generate rules engine output signals; and
using the rules engine output signals to generate a display on one or more of the mobile communications devices to show pre-specified features of the virtual experiment to simulate the specified experiment.

17. The computer program product according to claim 16, wherein the computer program code, when executed in the computer system performs the further:
receives specified data and instructions for the simulated specified experiment, the pre-configured data identifying said set of parameters.

18. The computer program product according to claim 17, wherein said pre-configured instructions includes said set of rules.

19. The computer program product according to claim 16, wherein the processing the parameter signals includes:
filtering the parameter signals to obtain filtered signals; and
combining the filtered signals according to the set of rules.

20. The computer program product according to claim 16, wherein the using the rules engine output signals to generate a display includes:
transmitting the rules engine output signal to a rendering module on a first of the mobile communications devices, and said rules engine output signals causing the rendering module to generate a visualization on a display area of the first mobile communications device showing a specified result of the simulated experiment.
